(19) United States
(12) Patent Application Publication
(10) Pub. No.: US 2003/0175034 A1
(43) Pub. Date: Sep. 18, 2003

(54) Method and apparatus for optical information transmission

(76) Inventor: Reinhold Noe, Paderborn (DE)

Correspondence Address: LERNER AND GREENBERG, P.A., POST OFFICE BOX 2480, HOLLYWOOD, FL, 33022-2480, US

(21) Appl. No.: 10/410,633

(22) Filed: Apr. 9, 2003

Related U.S. Application Data
(63) Continuation of application No. PCT/DE01/03780, filed on Sep. 27, 2001.

(30) Foreign Application Priority Data
Oct. 9, 2000 (DE) 100 50 266.0
Nov. 2, 2002 (DE) 100 54 400.2

(51) Int. Cl. H04B 10/00

(52) U.S. Cl. 398/152; 398/141

(57) ABSTRACT

A polarization of at least one modulated optical signal is varied at the transmitter side. Upon receiving the signals, propagation time variations of at least one optical signal are detected at the receiver side. These propagation time variations are determined preferably by evaluating the variations of the integral of the control signal of a voltage-controlled oscillator in the clock recovery and are a measure for existing polarization mode dispersion, which may be compensated by means of a polarization mode dispersion compensator.

### Cross-Reference to Related Application:

This application is a continuation of copending International Application No. PCT/DE01/03780, filed Sep. 27, 2001, which designated the United States and which was not published in English.

### BACKGROUND OF THE INVENTION

1. Field of the Invention:

The invention relates to an apparatus and a corresponding method for an optical information transmission and more particular to the detection of polarization mode dispersion.

Polarization mode dispersion (PMD) impairs high data rate optical transmission. In R. Noe et al., J. Lightwave Techn., 1999, pp. 1602-1616 a method for measurement of polarization mode dispersion has been given. This method relies on a spectral analysis of the electrical detected signal which is obtained from an intensity-modulated optical signal. A disadvantage is that the obtained control signal and the associated eye pattern closure are roughly proportional to each other. This means that distortions by polarization mode dispersion are detected only when they have already an unfavorable effect.

### SUMMARY OF THE INVENTION

It is therefore an object of the invention to specify an apparatus and a corresponding method for an optical information transmission which allow to measure even very small distortions caused by polarization mode dispersion with a low effort.

With the above and other objects in view there is provided, in accordance with the invention, an optical information transmission apparatus, comprising:

an optical transmitter for transmitting modulated optical signals; and

an optical receiver for receiving the modulated optical signals, and a control unit in the optical receiver for measuring propagation time variations of at least one of the optical signals.

In accordance with an added feature of the invention, the control unit in the optical receiver is configured to measure the propagation time variations, averaged over occurring values of a transmitter-sided modulation signal, of at least one of the optical signals.

In accordance with an additional feature of the invention, the optical transmitter is configured for a transmission of various polarization states of an entirety of at least one existing optical signal.

In accordance with another feature of the invention, the control unit includes a signal processing unit that is configured to process at least one signal generated in a context of recovering a clock signal, and for delivering a measurement signal for measurement of the propagation time variations.

In accordance with a further feature of the invention, the control unit comprises a voltage-controlled oscillator for determining a frequency of a clock signal as a function of a frequency control signal.

In accordance with again an added feature of the invention, the signal processing unit is configured to evaluate variations of an integral of the frequency control signal as the measurement signal.

In accordance with again an additional feature of the invention, the optical transmitter comprises a polarization scrambler for scrambling a polarization of the optical signal.

In accordance with again another feature of the invention, the optical transmitter comprises a phase difference modulating device for generating a differential phase modulation between at least two differently polarized optical signals of the optical signals. Preferably, the two differently polarized optical signals possess a non-constant complex envelope during a bit duration.

In accordance with again a further feature of the invention, there is provided a polarization mode dispersion compensator driven by a polarization mode dispersion control signal derived from the measurement signal.

With the above and other objects in view there is also provided, in accordance with the invention, a method for optical information transmission, which comprises:

transmitting a modulated optical signal with an optical transmitter;

receiving the optical signal with an optical receiver; and

measuring propagation time variations of at least one of the optical signals in the optical receiver.

In accordance with again an added feature of the invention, the method measures the propagation time variations, averaged over occurring values of a transmitter-side modulation signal, of at least one of the optical signals in the optical receiver.

In accordance with again an additional feature of the invention, the method comprises transmitting various polarization states of an entirety of at least one existing optical signal by the optical transmitter.

In accordance with again another feature of the invention, the method comprises processing at least one signal generated in a context of recovering a clock signal in the control unit, to generate a measurement signal for measurement of the propagation time variations.

The solution of the problem lies in forming the optical transmitter in such a way that it transmits signals with different polarizations so that these suffer different propagation delays in the presence of polarization mode dispersion (PMD), and that the optical receiver detects the signal propagation delays or the changes thereof. The thereby obtained control signal can be used to control for example a polarization mode dispersion compensator at the receiver side. For the widely used intensity modulation of an at least nearly fully polarized light signal the implementation of the method requires a polarization scrambler at the transmitter side. At the receiver side the control signal of the voltage-controlled oscillator (VCO) which provides the recovered bit clock is analyzed. The variations of its integral, in the frequency range where polarization modulations occur and hence also in frequency range in which the driving signals of the polarization scrambler lie, are a measure for existing polarization mode dispersion.

In another embodiment polarization division multiplex and a signal format which differs from the Non-Return-to-Zero signal format, e.g., the Return-to-Zero signal format, is used, where the phase difference between the polarization division multiplex signals is variable. At the receiver side the temporal position of the recovered data clock signal, which depends on polarization mode dispersion and usually also on the phase difference, is evaluated in at least one polarization division multiplex channel. Here again this preferably occurs by analysis of the frequency control signal of a VCO which provides the recovered bit clock signal.

Other features which are considered as characteristic for the invention are set forth in the appended claims.

Although the invention is illustrated and described herein as embodied in a method and apparatus for an optical information transmission, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is an inventive apparatus for information transmission,

FIG. 2 is a polarization division multiplex transmitter with a laser,

FIG. 3 is an inventive apparatus for information transmission,

FIG. 4 is an alternative embodiment of a polarization demultiplexer,

FIG. 5 is an inventive receiver,

FIG. 6 is a phase comparator,

FIG. 7 is an eye diagram,

FIG. 8 is a signal processing unit,

FIG. 9 is a common control unit,

FIG. 10 is another signal processing unit.

### DESCRIPTION OF THE PREFERRED EMBODIMENTS

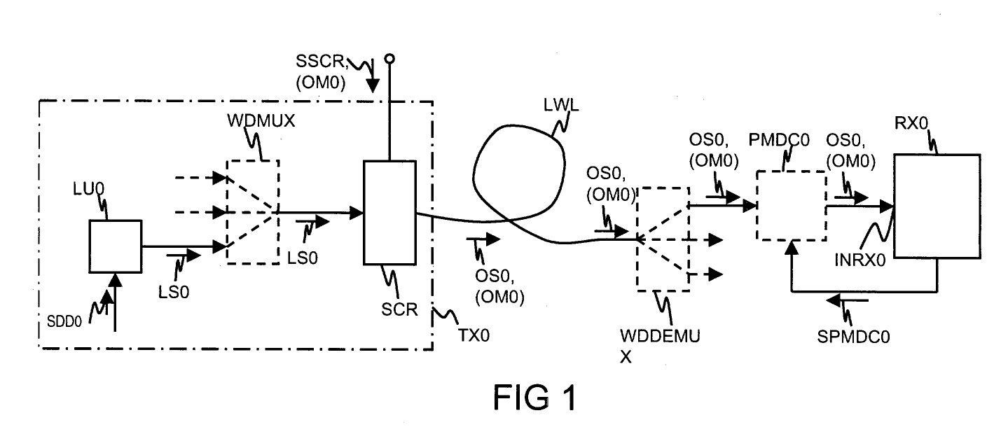

In an inventive apparatus for an information transmission according to FIG. 1 a preferably intensity-modulated first laser signal LS0 is generated in a first optical transmitter TX0. For this purpose for example a first transmitter-sided modulation signal SDD0 can be fed to a laser unit LU0 which comprises a laser and possibly a modulator. The first laser signal LS0 may traverse a multiplexer WDMUX which permits the addition of more laser signals with other optical transmitter frequencies. Subesequently it traverses a polarization scrambler SCR. Possibly needed optical and/or electrical amplifiers are not depicted here and in the following Figures. If a multiplexers WDMUX is used then the polarization scrambler SCR is preferably constructed for scrambling of the polarizations of all existing laser signals. The Polarization scrambler SCR generates time-variable output polarizations of the first laser signal LS0, the normalized Stokes vectors of which preferably lie not all in one plane and are formed so that the correlation matrix of the normalized Stokes vectors which results from temporal averaging is proportional to the unit matrix, to be more precise, to ⅓ times the unit matrix.

To this purpose the polarization scrambler SCR comprises preferably several electrooptical waveplates which rotate with different speeds, where a sequence of alternating quarter and half wave plates is advantageous.

Polarization scramblers which are at least approximately usable are given in M. Rehage et al., “Single- and Double-Stage Acoustooptical Ti:LiNbO₃ TE-TM Converters used in Wavelength-Selective Polarimeter and Polarization-Independent Depolarizer”, European Symposium on Advanced Networks and Services, Conference on Passive Fiber-Optic System Components, 2449-45, Mar. 20-24 1995, Amsterdam, in F. Heismann et al., “Electrooptic polarization scramblers for optically amplified long-haul transmission systems”, IEEE Photonics Technology Letters 6(1994)9, S. 1156-1158 or in B. H. Billings, “A monochromatic depolarizer”, J. Opt. Soc. Amer., vol. 41, pp. 966-975, 1951. Also the polarization mode dispersion compensator described in R. Noé et al., “Integrated optical LiNbO₃ distributed polarization mode dispersion equalizer in 20 Gbit/s transmission system”, Electronics Letters 35(1999)8, pp. 652-654 may be used as a polarization scrambler SCR if it is driven by alternating signals, preferably sine and cosind signals, which may have various frequencies. The polarization scrambler SCR receives at least one olarization scrambler signal SSCR with at least a first modulation frequency OM0. It delivers at its output a first optical signal OS0 which shows variable polarization and in which also the first modulation frequency OM0 manifests itself.

After traversing an optical fiber LWL which may exhibit polarization mode dispersion (PMD) and polarization-dependent loss (PDL) the first optical signal OS0 may traverse a demultiplexer WDDEMUX which, where applicable, separates other optical signals with other optical carrier frequencies. After this it may traverse a first polarization mode dispersion compensator PMDC0. The first polarization mode dispersion compensator PMDC0 comprises, e.g., one or more endless polarization transformers which are each followed by a piece of waveguide with polarization mode dispersion. The units formed thereby are cascaded. Likeweise, uninterrupted birefringent waveguides with embedded controllable mode converters are of use. Examples are described in R. Noé et al., “Polarization mode dispersion compensation at 10, 20 and 40 Gb/s with various optical equalizers”, IEEE J. Lightwave Technology, 17(1999)9, pp. 1602-1616 and in R. Noé et al., “Integrated optical LiNbO₃ distributed polarization mode dispersion equalizer in 20 Gbit/s transmission system”, Electronics Letters 35(1999)8, pp. 652-654.

Finally the first optical signal OS0 is fed to a first receiver input INRX0 of a first receiver RX0, which is constructed to be at least nearly polarization independent and is contstructed for intensity-modulated signals. The first receiver RX0 will be described later. It can deliver at least a first polarization mode dispersion control signal SPMDC0 for control of the first polarization mode dispersion compensator PMDC0.

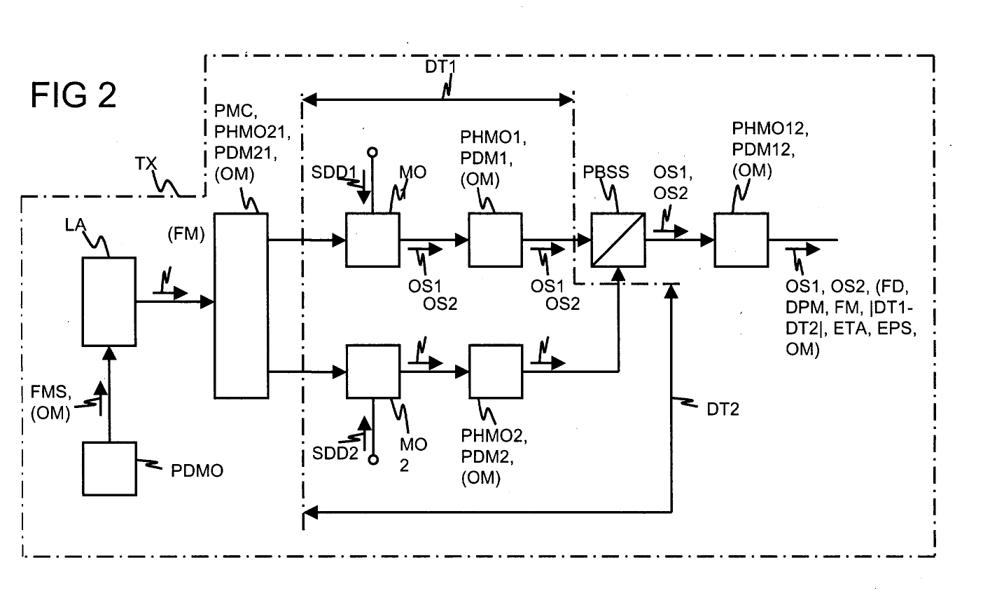

In another embodiment of the invention optical polarization division multiplex is being used. In a common optical transmitter TX according to FIG. 2, suitable for polarization division multiplex, the output signal of a preferably pulsed transmitter laser LA is split into two optical fibers with approximately equal mean powers by a transmitter-sided power splitter PMC. The transmitter-sided power splitter PMC can, e.g., be a polarization-maintaining fiber coupler. The thereby obtained signals are each passed through a modulator MO1, MO2 which are preferably formed as intensity modulators and where transmitter-sided modulation signals SDD1, SDD2, respectively, are impressed and thereby two further optical signals OS1, OS2 are generated. Here these are modulated using the so-called Return-to-Zero signal format. Other modulation- or signal formats with an envelope which is not constant during a bit duration can likewise be used. This refers for example to a phase alternation between subsequent bits. OS1 is a first and OS2 is a second of the further optical signals. These are combined by a transmitter-sided polarization beam splitter PBSS with preferably orthogonal polarizations. Instead of the transmitter-sided polarization beam splitter PBSS a simple directional optical coupler can also be used.

For the connections between the modulators MO1, MO2 and the transmitter-sided polarization beam splitter PBSS polarization-maintaining fibers may be provided, one of which is twisted by 90°. Alternatively, a mode converter may be provided in one of these connections.

In order to obtain a desired coherency of the further optical signals OS1, OS2 after their combination there is a differential phase modulation DPM between these further optical signals OS1, OS2, which is generated by a phase difference modulating means. Phase difference modulating means PDM1, PDM2, PDM12, PDM21, which can be used alternatively or additively, are angle modulators PHMO1, PHMO2 of one of the further optical signals OS1, OS2 or differential angle modulators PHMO12, PHMO21. Differential signifies here that the angle modulation is effective between the further optical signals OS1, OS2 which idealy have orthogonal polarizations. In the case of a thereby generated frequency shift a frequency difference FD will exist in the output optical fiber. Frequency shifters, also differential ones, which are apt for the realization of these first phase difference modulating means PDM1, PDM2, PDM12, PDM21, may operate in particular acoustooptically or electrooptically, and preferably with a full mode conversion in the case of phase difference modulating means PDM1, PDM2, PDM12 which do not act for a power division. Also a transmitter-sided power splitter PMC may be used as a phase difference modulating means PDM21, for example for the realization of an acoustooptical mode mode converter with a half power conversion which is followed by a polarization beam splitter.

In another embodiment of a polarization division multiplex transmitter the transmitter laser LA is being supplied with an optical frequency modulation signal FMS which is made available from another phasen difference modulating means PDM0. For example, a sinusoidal optical frequency modulation FM with a deviation of a few 100 MHz hardly changes the transmitter bandwidth of a 40 Gb/s transmitter. A propagation delay difference magnitude |DT1−DT2| unequal zero between the optical propagation delays DT1, DT2 of the further optical signals OS2, OS2 traversing the modulators MO1, MO2 between the transmitter-side power splitter PMC and the transmitter-sided polarization beam splitter PBSS translates the optical frequency modulation FM into the desired differential phase modulation DPM of the further optical signals OS1, OS2 behind the transmitter-sided polarization beam splitter PBSS. The differential phase modulation DPM possesses a spectrum which depends on the optical frequency modulation FM.

The differential phase modulation DPM adds itself to a static difference phase angle EPS which occurs at a given time between the further optical signals OS1, OS2.

The propagation delay difference magnitude |DT1−DT2| is preferably chosen equal to an integer multiple of the symbol duration, i.e., the distance between subsequent pulses of the transmitter laser LA. In embodiments in which the transmitter laser LA is not supplied with the optical frequency modulation signal FMS the propagation delay difference magnitude |DT1−DT2| is preferably chosen equal to zero.

The phase difference modulating means PDM1, PDM2, PDM12, PDM21, PDM0 receives at least one control signal with at least one further modulation frequency OM which also manifests itself in the differential phase modulation DPM.

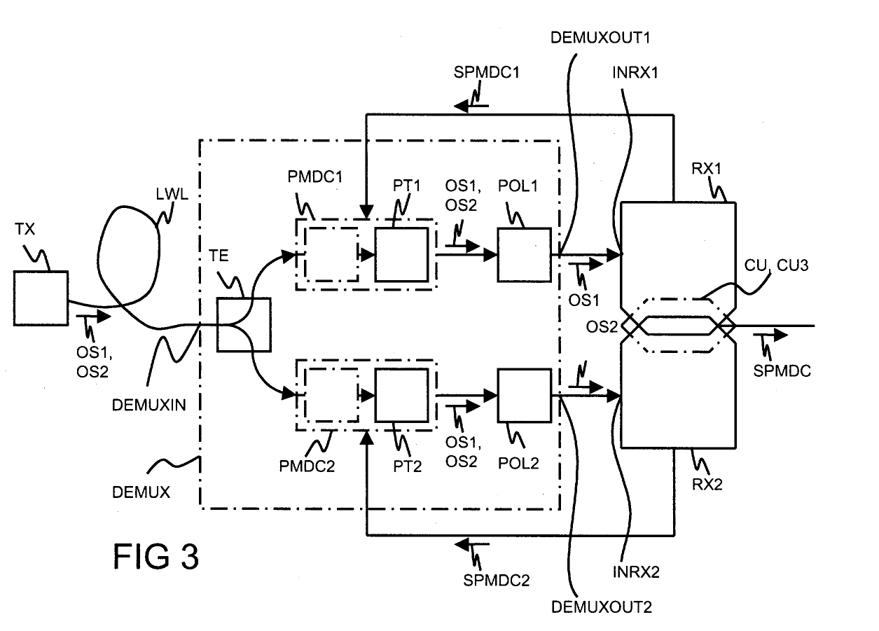

FIG. 3 shows the inventive apparatus for an information transmission with polarization division multiplex. The further optical signals OS1, OS2 are taken from the common transmitter TX and are transmitted over the optical fiber LWL.

At the receiver side the further optical signals OS1, OS2 are split in a receiver-sided power splitter TE into two receiver branches, where the input of the receiver-sided power splitter TE is at the same time the polarization demultiplexer input DEMUXIN of a polarization demultiplexer DEMUX. In each receiver branch there may be one more polarization mode dispersion compensators PMDC1, PMDC2 which shall equalized the distortions caused in the optical fiber LWL by polarization mode dispersion. The further optical signals OS1, OS2 also traverse a first and second polarization transformer PT1, PT2, respectively, which are preferably formed as endless. This first and second polarization transformer PT1, PT2 may as well be a part of the respective further polarization mode dispersion compensator PMDC1, PMDC2 which is adjacent to the following first and second polarization-sensitive elements POL1, POL2. After traversing the first or second polarization transformator PT1, PT2, respectively, the further optical signals OS1, OS2 are fed into a first and second polarization-sensitive element POL1, POL2, respectively, which are here constructed as polarizers. Thereby the first and second polarization-sensitive element POL1, POL2 select in the ideal case at least approximately at least in a temporal average the first and second optical signal OS1, OS2, respectively.

The output signals of the first and second polarization-sensitive elements POL1, POL2 are here in each case optical signals, but could in a coherent optical receiver, which possesses a polarization sensitivity according to the polarization of the local laser, as well be electrical heterodyne/homodyne signals.

The exits of the first and second polarization-sensitive elements POL1, POL2 are at the same time polarization demultiplexer outputs DEMUXOUT1, DEMUXOUT2 of the polarization demultiplexer DEMUX, and are connected to a first and second further receiver input INRX1, INRX2, respectively, of a first and second further receiver RX1, RX2, respectively, which latter are here constructed as optical receivers for intensity-modulated signals. The first and second further receivers RX1, RX2 may possess a common part which can be in particular a common control unit CU or an additional control unit CU3.

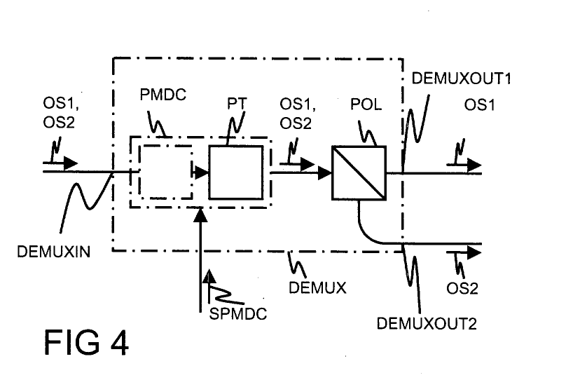

FIG. 4 shows an alternative embodiment of the polarization demultiplexer DEMUX. The further optical signals OS1, OS2 are connected to a common polarization transformer PT which preferably is constructed as endless. Before this the further optical signals OS1, OS2 may be passed through a common polarization mode dispersion compensator PMDC, which, however, may also contain the common polarization transformer PT and is driven by at least one common polarization mode dispersion control signal SPMDC. For the realization of the further polarization mode dispersion compensators PMDC1, PMDC2 and of the common polarization mode dispersion compensators PMDC with therein enclosed polarization transformers PT1, PT2, PT the embodiment described in R. Noé et al., “Integrated optical LiNbO₃ distributed polarization mode dispersion equalizer in 20 Gbit/s transmission system”, Electronics Letters 35(1999)8, pp. 652-654 is particularly suited.

The further optical signals OS1, OS2 are then connected to a common polarization-sensitive element POL which is preferably constructed as a polarization beam splitter. Its outputs are the polarization demultiplexer outputs DEMUXOUT1, DEMUXOUT2, and they deliver in the ideal case at least in a temporal average the first and second further optical signal OS1, OS2, respectively. The embodiment of FIG. 4 is simpler than that of FIG. 3, but the embodiment according to FIG. 3 is better suited particularly in cases in which there is no orthogonality of the further optical signals OS1, OS2.

The further receivers RX1, RX2 may deliver at least one further polarization mode dispersion control signal SPMDC1, SPMDC2, respectively, or at least one common polarization mode dispersion control signal SPMDC for control of the further polarization mode dispersion compensators PMDC1, PMDC2 and of the common polarization mode dispersion compensator PMDC.

The polarization of the entirety of possibly existing optical signals OS0, OS1, OS2 turns out to be the polarization state of all simultaneously existing superimposed optical signals OS0, OS1, OS2. The first optical transmitter TX0 delivers as this entirety just the first optical signal OS0. The common optical transmitter TX delivers as this entirety one or both of the further optical signals OS1, OS2.

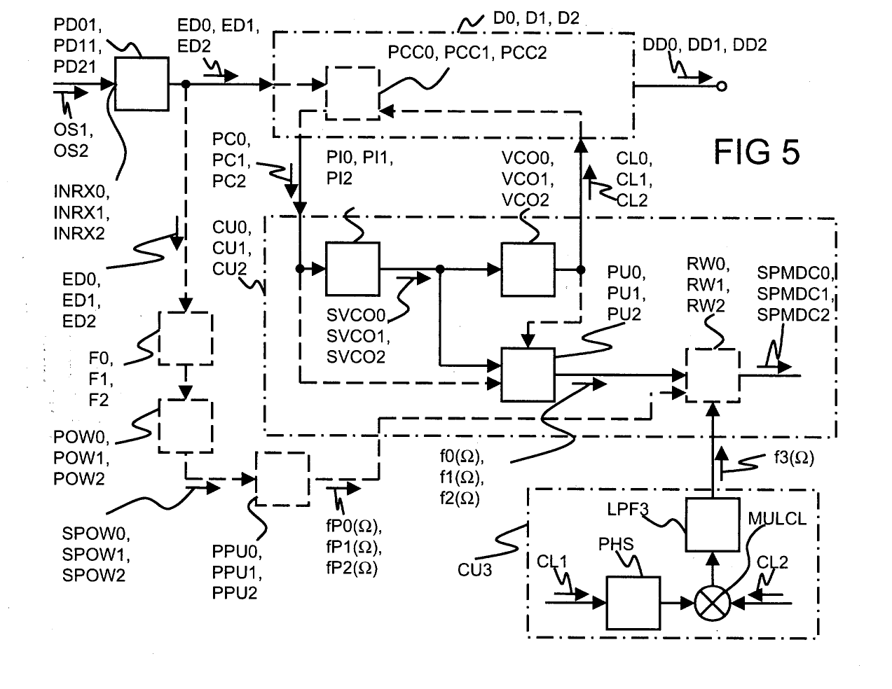

According to FIG. 5 each receiver RX0, RX1, RX2 comprises a photodetektor PD01, PD11, PD21, which detects the first, the first further and the second further optical signal OS, OS1, OS2, respectively, and delivers a first, a first further and a second further detected signal ED0, ED1, ED2, respectively. All these are electrical signals here. The detected signals ED0, ED1, ED2 are passed on to a first, a first further and a second further digital receiver D0, D1, D2, respectively. The digital receivers D0, D1, D2, which regenerate the detected signals ED0, ED1, ED2, each deliver a data signal DD0, DD1, DD2, respectively, which comprise an electrical signal each. If possibly existing polarization mode dispersion compensators PMDC0, PMDC1, PMDC2, PMDC are suitably controlled then the data signals DD0, DD1, DD2 correspond to the transmitter-sided modulation signals SDD0, SDD1, SDD2. This is typically given during operation; occasional bit errors of the data signals DD0, DD1, DD2 impair the function of the invention not or just insignificantly.

The digital receiver D0, D1, D2 delivers also a phase comparison signal PC0, PC1, PC2, which indicates whether the edges of the clock signal CL0, CL1, CL2 are on average passed on to the digital receiver D0, D1, D2 too early, just right, or too late. Usually the phase comparison signal PC0, PC1, PC2 is designed in such a way that its polarity and amplitude indicates the direction and the magnitude of the temporal error; the value zero then corresponds to edges of the clock signal CL0, CL1, CL2 which are in the time domain placed perfectly.

The first receiver RX0 features a first control unit CU0. The two further receivers RX1, RX2 may comprise a first further and second further control unit CU1, CU2, respectively. From a first or two further voltage-controlled oscillators VCO0, VC01, VC02 a first clock signal or two further clock signals CL1, CL2, which control the regeneration process, are delivered to the digital receiver D0, D1, D2.

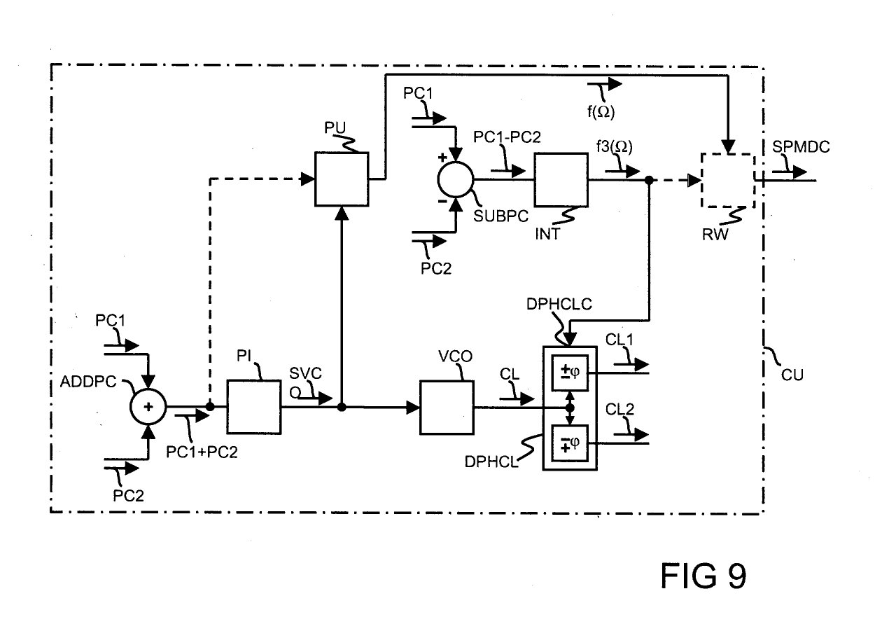

The two further receivers RX1, RX2 may feature a common control unit as depicted in FIG. 9 instead of or in addition to the two further control units CU1, CU2. Inside it a common voltage-controlled oscillator VCO delivers a common clock signal CL which is split in a differential clock phase shifter DPHCL with selectable phase difference in such a way that the two further clock signals CL1, CL2 are resulting. The selectable phase difference is controlled as a preferably monotonous function of a signal incident at a clock phase control signal input DPHCLC.

A first or two further or a common clock signal controller PI0, PI1, PI2, PI which are typically designed as proportional-integral controllers, are driven by the first or the two further phase comparison signals PC0, PC1, PC2 or by a common phase comparison signal PC1+PC2 which is generated in an adder ADDPC as the sum of the two further phase comparison signals PC1, PC2, respectively. They control by a first or two further or a common frequency control signal SVCO0, SVCO1, SVCO2 the frequency of the first or of the two further or of the common voltage-controlled oscillator VCO0, VCO1, VCO2, VCO, respectively. The device within the digital receiver D0, D1, D2 for generation of the phase comparison signal PC0, PC1, PC2, the clock signal controller PI0, PI1, PI2, PI and the voltage-controlled oscillator VCO0, VCO1, VCO2, VCO constitute together a phase-locked loop.

Embodiments of a digital receiver D0, D1, D2 including a phase comparator PCC0, PCC1, PCC2 for generation of a phase comparison signal PC0, PC1, PC2 are known, for example, from German patent application P 44 43 417.0.

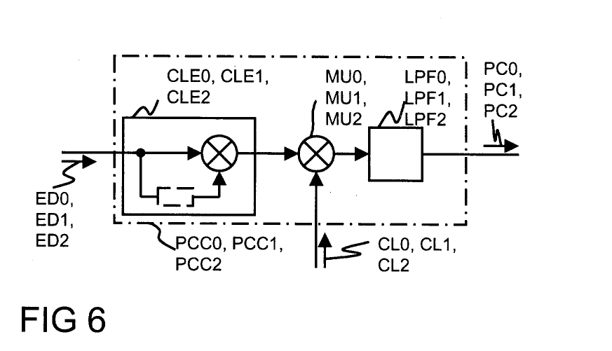

Alternatively, a phase comparator PCC0, PCC1, PCC2 according to FIG. 6 with a clock line extractor CLE0, CLE1, CLE2 may be provided within the digital receiver D0, D1, D2 in the simplest case. The clock line extractor CLE0, CLE1, CLE2 multiplies the detected signal ED0, ED1, ED2 by itself, wherein one of the signals fed to the clock line extractor CLE0, CLE1, CLE2 may be delayed with respect to the other for example by half a bit duration. It delivers a signal to an input of a multiplier MU0, MU1, MU2. Another input of the multiplier MU0, MU1, MU2 is driven by the clock signal CL0, CL1, CL2. At the output of the multiplier MU0, MU1, MU2 a lowpass filter LPF0, LPF1, LPF2 is provided; its output signal is the phase comparison signal PC0, PC1, PC2.

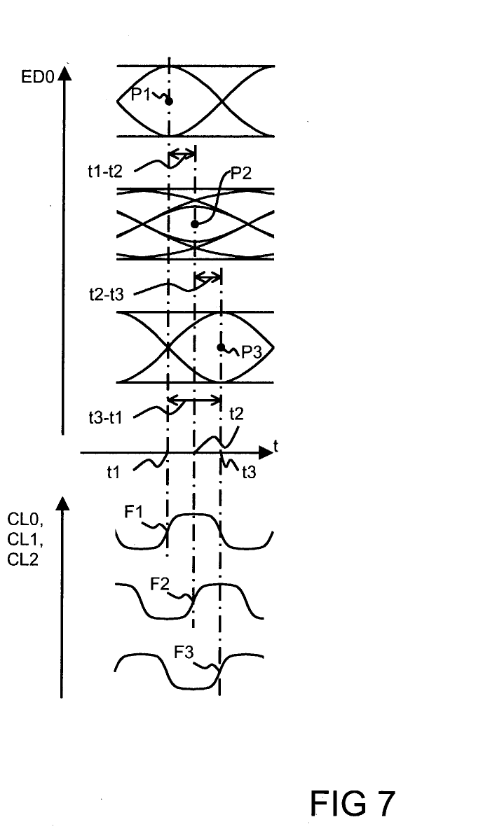

FIG. 7 shows eye diagrams of the first detected signal ED0above the horizontal axis, which denotes the sampling time t. The triggering corresponds to the clock of the first transmitter-sided modulation signal SDD0. Depending on the transmitter-sided polarization and polarization mode dispersions of the optical fiber LWL and possibly of the first polarization mode dispersion compensator PMDC0 various eye diagrams may result, the optimum sampling points P1, P2, P3 of which lie at different sampling instants t1, t2, t3. The polarization scrambler SCR makes sure that in the presence of polarization mode dispersion at least two different sampling instants t1, t2, t3 occur, where propagation time variations of the first optical signal OS0 are given by t1−t2, t2−t3 and t3−t1. Usually only the absolute values of the propagation time variations matter. Ideally the polarization scrambler SCR operates in such a way that also an extremely early sampling instant t1 and an extremely late sampling instant t3 will occur. When eye diagrams of the first detected signal ED0 are displayed the difference t3−t1 between these extreme sampling instants t1, t3 is at least approximately equal to any existing differential group delays between the principal states-of-polarization.

Depending on instantaneous differential phase modulation DPM and existing polarization mode dispersion in the optical fiber LWL and in the further and common polarization mode dispersion compensators PMDC1, PMDC2, PMDC, eye diagrams can be obtained in the two furter receivers RX1, RX2 with optimum sampling points having also different sampling instants t1, t2, t3; this is preferably measured when the polarization transformer PT1, PT2, PT2 is well set.

Below the horizontal axis, which denotes the sampling time t, FIG. 7 shows oscillograms of the clock signals CL0, CL1, CL2 which belong to the sampling instants t1, t2, t3. Provided the clock recovery circuits work optimally, the edges F1, F2, F3 of the clock signal or clock signals CL0, CL1, CL2 coincide with the desired sampling instants t1, t2, t3. Here the edges F1, F2, F3 are the rising ones but they could as well be the falling edges. Or, in a digital receiver D0, D1, D2 constructed as explained in the german patent application P 44 43 417.0 they could alternately be the rising and falling edges of a clock signal CL0, CL1, CL2 which has a frequency equal to half the bit clock frequency.

According to the invention the differences between the sampling instants t1, t2, t3, i.e., propagation time variations t1−t2, t2−t3, t3−t1 are analyized and used as a measure for existing polarization mode dispersion (PMD). The sampling time t, which oscillates in the course of time forth and back between the various sampling instants t1, t2, t3, is at least approximately proportional to the integral of the frequency control signal SVCO0, SVCO1, SVCO2, SVCO. The first or two further or common frequency control signals SVCO0, SVCO1, SVCO2, SVCO are fed into a first or into two further or into a common signal processing unit PU0, PU1, PU2, PU which analyzes the integral or the temporal variations of the integral of the frequency control signals SVCO0, SVCO1, SVCO2, SVCO which are being fed into it.

Practically the sampling time t which is defined by the clock signal CL0, CL1, CL2 tracks the truly desired sampling instants t1, t2, t3 only with a certain delay which is caused by the phase-locked loop. For this reason the corresponding phase comparison signals PC0, PC1, PC2, PC1+PC2 may be processed instead of or in addition to the frequency control signals SVCO0, SVCO1, SVCO2, SVCO in the signal processing unit PU0, PU1, PU2, PU. Processing of the clock signals CL0, CL1, CL2 in the first and in the two further signal processing units PU0, PU1, PU2 is likewise possible.

The signal processing unit PU0, PU1, PU2, PU delivers at least a first or a first and a second further, or a common measurement signal f0(Ω), f1(Ω), f2(Ω), f(Ω) at its output, which each depends at least on the polarization mode dispersion vector Ω.

The measurement signal f0(Ω), f1(Ω), f2(Ω), f(Ω) may be fed to a first polarization mode dispersion controller RW0 or to a first further or second further polarization mode dispersion controller RW1, RW2 or a common polarization mode dispersion controller RW, respectively, which derives from it a first or the two further or a common polarization mode dispersion control signal SPMDC0, SPMDC1, SPMDC2, SPMDC, respectively.

Since the polarization adjustment in the polarization demultiplexer DEMUX is also influence by the two further or the common polarization mode dispersion compensator PMDC1, PMDC2, PMDC the two further or the common polarization mode dispersion control signal SPMDC1, SPMDC2, SPMDC, respectively, may drive at least partly also the first and second or the common polarization transformator PT1, PT2, PT, respectively.

The modulation frequency OM0, OM and perferably also multiples thereof are preferably chosen so that they are very small compared to the bit clock frequency of the optical signals OS0, OS1, OS2, but at the same time large compared to that linewidth of the voltage-controlled oscillator VCO0, VCO1, VCO2, VCO which is observed without phase-locked loop, and the corner frequency of the phase-locked loop which comprises this voltage-controlled oscillator VCO0, VCO1, VCO2, VCO. If the invention is dimensiond in ths way then the measurmement signals f0(Ω), f1(Ω), f2(Ω), f(Ω) possess a particularly high signal-to-noise ratio. Suitable modulation frequencies OM0, OM lie for example between 100 kHz and 10 MHz.

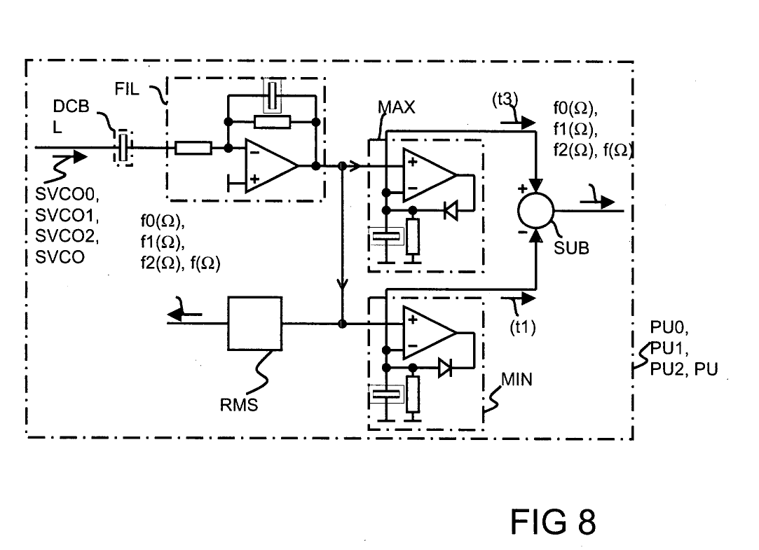

In FIG. 8 a signal processing unit PU0, PU1, PU2, PU is depicted more in detail. The frequency control signal SVCO0, SVCO1, SVCO2, SVCO fed into it is passed through a direct current blocker DCBL to a filter FIL, which is dimensioned as a lowpass filter with a corner frequency that is preferably chosen lower than the modulation frequency OM0, OM, and which therefore operates approximately as an integrator in the frequency range of the modulation frequency OM0, OM. The output signal of the filter FIL is passed on to a maximum hold device MAX and a minimum hold device MIN. Their output signals are at least approximately linear functions of the extreme sampling instants t1, t3. The output signals of the maximum hold device MAX and the minimum hold device MIN are subtracted in a first subtractor SUB.

In the case of the first signal processing unit PU0 it thereby results a first measurement signal f1 (Ω), which is a function of the length of the polarization mode dispersion vector Ω. That function is preferably dimensioned to be linear. In the case of one of the further or the common signal processing units PU1, PU2, PU it results thereby one of the two further or the common measurement signal f1(Ω), f2(Ω), f(Ω), respectively, which is a preferably linear function of the length of that second component Ω23 of the polarization mode dispersion vector Ω which in the space of the normalized Stokes vectors is perpendicular to the first component Ω1 of the polarization mode dispersion vector Ω, the first component Ω1 of the polarization mode dispersion vector being parallel to the polarizations of the two further optical signals OS1, OS2.

In an alternative embodiment the output signal of the filter FIL is directed to a root-mean-square measuring device RMS, the output signal of which is the first or one of the two furhter or the common measurement signal f0(Ω), f1(Ω), f2(Ω), f(Ω), respectively.

The hold time constants of the maximum hold device MAX and the minimum hold device MIN, corresponding to those of the root-mean-square measuring devices RMS, are preferably chosen so that they have the same order of magnitude as or are slightly larger than the cycle period which corresponds to the modulation frequency OM0, OM.

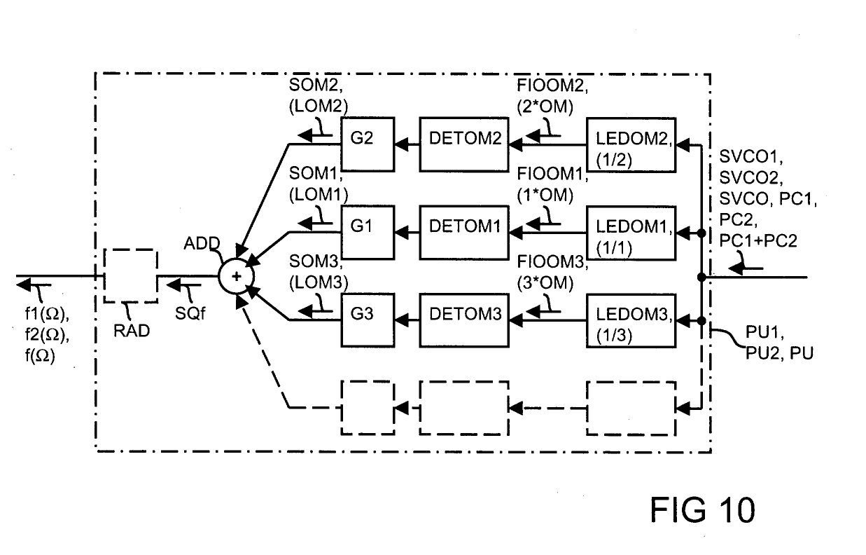

FIG. 10 shows an alternative embodiment of a further or of the common signal processing unit PU1, PU2, PU, which, however, possibly with a slight rework, can also be used as the first signal processing unit PU0.

For this purpose the common optical transmitter TX features a differential phase modulation at a further modulation frequency OM. This can be reached for example by an at least approximately sinusoidal frequency modulation FM that is brought about by a sinusoidal frequency modulation signal FMS. If the optical frequency modulation FM is generated by a—preferably sinusoidal—direct modulation of a semiconductor laser then the further optical signals OS1, OS2 will exhibit an unwanted amplitude modulation in addition to the wanted differential phase modulation DPM which is generated by the optical frequency modulation FM and possesses a modulation index ETA. The value of the modulation index ETA is in the following understood to be a peak excursion in radiants. The unwanted amplitude modulation is independent of the polarization states selected at the receiver side. It therefore makes the analysis of the propagation time variations t1−t2, t2−t3, t3−t1 of the further optical signals OS1, OS2 more difficult. In such cases it may be useful to analyze multiples n*OM, for example n=2, 3, 4, . . . , of the further modulation frequency OM.

At least for a sinusoidal frequency modulation FM the amplitudes of even (n=0, 2, 4, . . . ) and odd (n 32 1, 3, 5, . . . ) multiples n*OM of the further modulation frequency OM are proportional to cos and sin, respectively, of a phase angle EP, which results from the sum of the static difference phase angle EPS that depends sensitively on the propagation delay difference magnitude |DT1−DT2| between the optical propagation delays DT1, DT2, and a generally unknown angle offset.

According to the principle of the invention it is possible to evaluate at least one even and simultaneously at least one odd multiple of the further modulation frequency OM. This allows to obtain a first further and a second further, or a common measurement signal f1(Ω), f2(Ω), f(Ω) which is a preferably linear function of cos\hat{ }2(EP)+sin\hat{ }2(EP)=1, i.e., it is independent of the phase angle EP.

As an input signal of one of the further or of the common signal processing units PU1, PU2, PU serves a further or a common frequency control signal SVCO1, SVCO2, SVCO, respectively, or phase comparison signal PC1, PC2, PC1+PC2, respectively. It is fed into several bandpass filters LEDOMn with n=1,2,3, . . . , which select each the corresponding multiple n*OM of the further modulation frequency OM. The magnitude of the transfer function of the bandpass filter LEDOMn have that value which is necessary to make its output signal, i.e., the bandpass filter output signal FIOOMn, proportional to spectral components of the propagation time variations t1−t2, t2−t3, t3−t1 at the multiple n*OM of the further modulation frequency OM. If a frequency control signal SVCO1, SVCO2, SVCO is used, which corresponds at least approximately to the temporal derivative of the sampling time t, then an inverse operation which is equivalent to an integration has to be conducted. This means that the magnitude of the transfer function of the bandpass filter LEDOMn is assigned the value 1/n.

Thereby the bandpass filter output signals FIOOMn of the bandpass filters LEDOMn get amplitudes which are ideally each proportional to Jn with integer n, i.e., the Bessel function of the first kind and order n, and alse each proportional to cos(EP) or sin(EP) for even or odd multiples n*OM, respectively, and finally also proportional to the sought measurement signal f1(Ω), f2(Ω), f(Ω). The bandpass filter output signals FIOOMn are each fed to a power detector DETOMn, the output signals of which are weighted, i.e., multiplied, in weighting units Gn by a respective power transfer factor LOMn gewichtet. The output signals of the weighting units Gn are summation signals SOMn. These are added in a further adder ADD, so that the square SQf of the sought measurement signal f1(Ω), f2(Ω), f(Ω) results. If this square SQf with a square-law dependence of at least one component of the polarization mode dispersion vector Ω can not be used as the sought measurement signal f1(Ω), f2(Ω), f(Ω) then the square root of this square SQf is extracted in a square-root extractor RAD, by which process results the sought measurement signal f1(Ω), f2(Ω), f(Ω) with a linear dependence of at least one component of the polarization mode dispersion vector Ω. The sought measurement signal f1(Ω), f2(Ω), f(Ω) is an output signal of one of the further or of the common signal processing units PU1, PU2, PU.

In a first embodiment n=1,2 is chosen and LOM1*J1(ETA)\hat{ }2=LOM2*J2(ETA)\hat{ }2 is set, which is for example at least nearly possible if |J1(ETA)|=|J2(ETA)| is obtained upon choosing a deviation ETA=2,63 and if LOM1=LOM2 is chosen.

It is possible that the modulation index ETA is subject to variations in the course of time, for example by laser ageing. In order to keep detection still to first order independent of the phase angle EP the sought measurement signal f1(Ω), f2(Ω), f(Ω) should to first order not depend on the modulation index ETA. This goal is reached for example by n=1,2,3 and at least approximately the dimensioning LOM1=0,72852*LOM2, LOM3=1,6036*LOM2 and ETA=3.0542. Instead, n=2,3,4, LOM2=0,64066*LOM3, LOM4=1,3205*LOM3 and at least approximately ETA=4,2011 may be chosen. These values generally hold only for an exactly sinusoidal differential phase modulation DPM, which can be realized in practice only with reservations.

In the case of a distorted differential phase modulation DPM or if also an amplitude modulation occurs in addition to the optical frequency modulation the needed power transfer factors LOMn may differ from the above-mentioned values. However, if the differential phase modulation DPM is dimensioned to be linear, for example through the use of a frequency shifter, then n=1 may be chosen in conjunction with a LOM1 which may be chosen arbitrarily within wide limits.

Further variations of the principle of the invention are possible by providing other temporal courses of the differential phase modulation DPM between both optical signals OS1, OS2, for example by application of not just the further modulation frequency OM but also at least one multiple n*OM thereof with n=2,3, . . . . Such temporal courses are preferably formed in such a way that the evaluation of the propagation time variations t1−t2, t2−t3, t3−t1 is as independent as possible of the amplitudes of the differential phase modulation DPM or the frequency modulation signal FMS.

In practice an adaptive formation of the power transfer factoren LOMn by variable weighting units Gn is advantageous.

The function of the signal processing unit PU0, PU1, PU2, PU according to FIG. 10 may preferably be realized by digital signal processing. The bandpass filters LEDOMn are realized by calculation of the Fourier coefficients of n-th order of the respective input signal with the modulation frequency OM0, OM as a reference period. In this process these Fourier coefficients are multiplied by 1/n if the integration is necessary as an inverse operation. These are the bandpass filter output signals FIOOMn. The power detectors DETOMn are realized by taking the squared magnitudes of these bandpass filter output signals FIOOMn formed as Fourier coefficients.

The further calculation steps which are necessary for one pass of the signal processing unit PU0, PU1, PU2, PU according to FIG. 10 are presented in the following as an excerpt of a program which is written in the programming language Matlab.

% form spectral power vector SP=[SP1; SP2; SP3];

% calculated measurement signal SQf=transpose(LOM)*SP;

% update relative weights

SPrelest=SPrelest+SPrelestgain*SP;

SPrelest=SPrelest*(2−sum(SPrelest));

% modify weights

% Here the DC component of the spectral powers is removed,

% assuming SPrelest is an accurate estimate of the

% relative power distribution.

% Obtain a signal which is fairly independent of total power

% fluctuations

SPw=SP−SPrelest*sum(SP);

% remove mean value

SPw=SPw−mean(SPw);

% correlate powers in order to obtain error signal

rawerrors=SPw*SQf;

% integration

LOM=LOM−(weightgain.*rawerrors);

% keep weight sum constant

LOM=LOM*(2−sum(LOM));

The square SQf of the sought measurement signal f1(Ω), f2(Ω), f(Ω) is obtained by a scalar multiplication of a spectral power vector SP, which comprises spectral powers SP1, SP2, SP3, by a power transfer vector LOM containing the power transfer factors LOM1, LOM2, LOM3. The power transfer vector LOM is being adaptively modified in the following.

To this purpose an estimation vector SPrelest, reflecting the longterm behavior, is among other things determined. It contains the relative fractions of the spectral powers SP1, SP2, SP3 as components. On grounds of the taken measurement of the spectral power vector SP the estimation vector SPrelest is being integrated with an integration gain SPrelestgain and thereafter normalized to have the sum value 1 with help of an approximation formula.

Subsequently the expectation values of the mean values of the spectral power vector SP, which is obtained by taking the product SPrelest*sum(SP) of the estimation vector SPrelest with the sum sum(SP)of the spectral powers SP1, SP2, SP3, are subtracted from the spectral power vector SP, so that on average it remains a zero-mean spectral power alternating component vector SPw. This spectral power alternating component vector SPw is, if necessary after subtraction of its mean mean(SPw), correlated with the square SQf, from which action results an error vector rawerrors. The error vector rawerrors is being multiplied by a weight gain weightgain and is then subtracted from the weight vector G. Finally the power transfer vector LOM is normalized with help of an approximatio formula to have the sum value 1.

Before this program section is executed for the first time some variables must be preset, which can be done by the following Matlab lines:

SPrelest=[0; 0; 0];

SPrelestgain=1e−4;

LOM=[1; 1; 1]/3;

weightgain=1e−6;

In practice lower integration gain SPrelestgain and weight gain weightgain lead to better adaptation results at the expense of the adaptation speed. The program adapts the weight vector in a wide range of existing modulation indexes ETA, e.g., for ETA=2,9. This includes the possibility of the optical frequency modulation FM being distorted with respect to a sinusoidal shape. Other, likewise usable embodiments of the signal processing unit PU0, PU1, PU2, PU are described in the German patent application P 10019932.1.

The signal processing unit PU0, PU1, PU2, PU may detect the propagation time variations t1−t2, t2−t3, t3−t1 synchronously instead of the asynchronous evaluation used in the above embodiments. This requires at the receiver side a knowledge of the modulation frequency OM0, OM, which may be generated by a clock recovery unit or for example by a temporal reference which is being transmitted together with the optical signal OS0, OS1, OS2, e.g., as a frame clock signal of a bit error correction algorithm.

In the common control unit CU according to FIG. 9 the difference of the further phase comparison signale PC1, PC2 is calculated in a second subtractor SUBPC as an additional phase comparison signal PC1−PC2, and is passed on to an additional controller INT, which preferably is formed as an integrator. At its output it delivers an additional measurement signal f3(Ω) which is also a function at least of the polarization mode dispersion vector Ω, preferably a linear one. The additional measurement signal f3(Ω) is passed on to the clock phase control signal input Clock phase control signal input DPHCLC, so that the phase difference in the clock phase shifter DPHCL is set in such a way that the additional phase comparison signal PC1−PC2 becomes at least approximately zero. The additional measurement signal f3(Ω) is at least approximately proportional to that first componente Ω1 of the polarization mode dispersion vector Ω which is parallel to the polarizations of the further optical signals OS1, OS2. The additional measurement signal f3(Ω) may, for example for a minimization of the first component Ω1 of the polarization mode dispersion vector Ω, delivered to the common polarization mode dispersion controller RW.

As an alternative to the generation of the additional measurement signal f3(Ω) in the common control unit CU this can also be generated in an additional control unit CU3. It is likewise depicted in FIG. 5 and is needed only once for both further receivers RX1, RX2. In the additional control unit the two further clock signals CL1, CL2, one of which is being phase shifted by 90° or −90°0 in a phase shifter PHS, is passed on to two inputs of a clock signal multiplier MULCL. The output signal of the clock signal multiplier MULCL is passed on to an additional lowpass filter LPF3 which delivers from its output the additional measurement signal f3(Ω). The additional measurement signal f3(Ω) may be delivered to the two further polarization mode dispersion controllers RW1, RW2.

The invention can also be combined with other methods and apparatus for polarization mode dispersion detection, for example those known from R. Noe et al., J. Lightwave Techn., 1999, pp. 1602-1616.

The polarization transformers PT1, PT2, PT may for example be controlled evaluating interference signals, correlation signals or switching signals according to the german patent application P 10019932.1, the publication S. Hinz et al., “Optical NRZ 2×10 Gbit/s Polarization Division Multiplex Transmission with Endless Polarization Control Driven by Correlation Signals”, Electronics Letters 36(2000)16, pp. 1402-1403 or the German patent application 10035086.0. In particular, spectral components occurring in the further detected signals ED1, ED2 at multiples n*OM with n=1,2,3, . . . of the further modulation frequency OM may be detected and minimized by suitable settings of the polarization transformers PT1, PT2, PT.

The further optical signals OS1, OS2 are modulated in the common optical transmitter TX preferably in an overlapping fashion or even without time shift, for example with simultaneosly acting further transmitter-sided modulation signals SDD1, SDD2.

In a further embodiment there are also devices which detect further distortions, for example a detrimental kind of higher-order polarization mode dispersion which can be found in spite of a first-order polarization mode dispersion compensation. To this purpose a measurement device POW0, POW1, POW2 may be used which is preferably formed as a power detector. The detected signal ED0, ED1, ED2 is fed into it—if necessary after passing a spectral shaping filter F0, F1, F2 which may be preferably formed as a highpass or a bandpass filter. The measurement device POW0, POW1, POW2 delivers a measurement device output signal SPOW0, SPOW1, SPOW2, which represents the power of at least one spectral component of the detected signal ED0, ED1, ED2. The measurement device output signal SPOW0, SPOW1, SPOW2 is delivered to an additional signal processing unit PPU0, PPU1, PPU2, which is preferably constructed like the above-described signal processing units PU0, PU1, PU2, PU. The additional signal processing unit PPU0, PPU1, PPU2 delivers a measurement output signal fP0(Ω), fP1(Ω), fP2(Ω) which can be passed on to the first polarization mode dispersion controller RW0, or the first further or second further polarization mode dispersion controller RW1, RW2, respectively. A minimized distortion is indicated preferably if the measurement output signal fP0(Ω), fP1(Ω), fP2(Ω) features a minimum of variations. The first, first further or second furter polarization mode dispersion controller RW0, RW1, RW2 controls the respective first, first further or second further polarization mode dispersion compensator PMDC0, PMDC1, PMDC2 in such a way that this state is achieved.

In a further embodiment of the invention the modulators MO1, MO2 are formed as phase modulators for binary phase shift keying, preferably for binary or quaternary phase shift keying, or the first laser unit LU0 generates such a signal. A non-zero transmitter-sided propagation delay difference magnitude |DT1−DT2| is usually not necessary here. At the receiver side the propagation time variations t1−t2, t2−t3, t3−t1 are evaluated for example by correlation techniques. Preferably a regenerated digital signal DD0, DD1, DD2 is correlated with a detected signal ED0, ED1, ED2.

Instead of the use of further polarization sensitive elements POL1, POL2 that are formed as polarizers and are followed by further receivers RX1, RX2 which are formed as direct detection receivers the further polarization sensitive elements POL1, POL2 with their respective subsequent further receivers RX1, RX2 can also be formed as coherent receivers, for example heterodyne, homodyne or phase diversity receivers.

According to the principle of the invention the evaluation of propagation time variations t1−t2, t2−t3, t3−t1 has been described above using signals SVCO0, SVCO1, SVCO2, SVCO, PC0, PC1, PC2, PC1+PC2, PC1−PC2, CL0, CL1, CL2 which occur when the clock signal CL0, CL1, CL2, CL is recovered. As an alternative to the advantageous evaluation of variations of the integral of the frequency control signals SVCO0, SVCO1, SVCO2, SVCO a measurement signal f0(Ω), f1(Ω), f2(Ω), f0(Ω), f3(Ω) can also be obtained by determining the relative delay of a clock signal CL0, CL1, CL2, CL with respect to an additional clock signal CLX that acts as a temporal reference signal. The additional clock signal CLX can for example be taken from an optical receiver which receives a signal at another optical wavelength, or can be averaged from several such receivers by a phase averaging process.

The foregoing is merely illustrative of the principles of the invention. Those skilled in the art will be able to devise numerous arrangements which, although not explicitly shown or described herein, nevertheless embody those principles that are within the spirit and the scope of the invention. For example, based on the foregoing, it would be obvious to a skilled practitioner to select and shape the range of frequencies of the frequency control signals SVCO0, SVCO1, SVCO2, SVCO to be evaluated as well as to select and shape the clock recovery phase-locked loop transfer characteristics in such a way that the signal-to-noise ratio of the polarization mode dispersion detection is maximized.

List of reference symbols

| | |
|---|---|
| LU0 | laser unit |
| LA | transmitter laser |
| FM | optical frequency modulation |
| FMS | frequency modulation signal |
| PMC | transmitter-sided power splitter |
| MO1, MO2 | modulators |
| SDD0, SDD1, SDD2 | transmitter-sided modulation signals |
| DD0, DD1, DD2 | data output signals |
| OS0, OS1, OS2 | optical signals |
| PDM1, PDM2, PDM12, | phase difference modulating means |
| PDM21, PDM0 | angle modulator |
| PHMO1, PHMO2 | |
| PBSS | transmitter-sided polarization beam |
| | splitter |
| PHMO12 | differential angle modulator |
| DPM | differential phase modulation |
| FD | frequency difference |
| DT1, DT2 | propagation delays |
| \|DT1 − DT2\| | propagation delay difference magnitude |
| TX0, TX | optical transmitter |
| LWL | optical fiber |
| RX0, RX1, RX2 | receiver |
| INRX0, INRX1, INRX2 | receiver input |
| PMDC0, PMDC1, PMDC2, | polarization mode dispersion |
| PMDC | compensators |
| PT1, PT2, PT | polarization transformers |
| SCR | polarization scrambler |
| SSCR | polarization scrambler signal |
| LS0 | first laser signal |
| OM0, OM | modulation frequency |
| SPMDC0, SPMDC1, | polarization mode dispersion control |
| SPMDC2, SPMDC | signal |
| WDMUX | multiplexer |
| WDDEMUX | demultiplexer |
| DEMUX | polarization demultiplexer |
| DEMUXIN | polarization demultiplexer input |
| DEMUXOUT1, DEMUXOUT2 | polarization demultiplexer output |
| ETA | modulation index |
| EPS | difference phase angle |
| EP | phase angle |
| TE | receiver-sided power splitter |
| POL1, POL2, POL | polarization sensitive elements |
| CU0, CU1, CU2, | control unit |
| CU, CU3 | |
| PD01, PD11, PD21 | photodetectors |
| ED0, ED1, ED2 | detected signals |
| D0, D1, D2 | digital receiver |
| PC0, PC1, PC2, | phase comparison signal |
| PC1 + PC2, PC1 − PC2 | |
| CL0, CL1, CL2, | clock signal |
| CL, CLX | |
| PCC0, PCC1, PCC2 | phase comparator |
| CLE0, CLE1, CLE2 | clock line extractor |
| MU0, MU1, MU2 | multiplier |
| LPF0, LPF1, | lowpass filter |
| LPF2, LPF3 | |
| PI0, PI1, PI2, PI | clock signal controller |
| RW0, RW1, RW2, RW | polarization mode dispersion controller |
| PU0, PU1, PU2, PU | signal processing unit |
| fO(Ω), f1(Ω), | measurement signal |
| f2(Ω), f(Ω), f3(Ω) | |
| MULCL | clock signal multiplier |
| PHS | phase shifter |
| P1, P2, P3 | optimum sampling point |
| t1, t2, t3 | sampling instant |
| t | sampling time |
| t1 − t2, t2 − t3, t3 − t1 | propagation time variation |
| SVCO0, SVCO1, | frequency control signal |
| SVCO2, SVCO | |
| VCO0, VCO1, | voltage-controlled oscillator |
| VCO2, VCO | |
| DPHCL | differential clock phase shifter |
| DPHCLC | clock phase control signal input |
| ADDPC, ADD | adder |
| SUBPC, SUB | subtractor |
| DCBL | direct current blocker |
| FIL | filter |
| MAX | maximum hold device |
| MIN | minimum hold device |
| Ω | polarization mode dispersion vector |
| RMS | root-mean-square measuring device |
| LEDOMn | bandpass filter |
| (n = 0, 1, 2, . . . ) | |
| n * OM | multiples of a modulation frequency |
| FIOOMn | bandpass filter output signal |
| DETOMn | power detector |
| Gn | weighting unit |
| SOMn | summation signals |
| LOMn | power transfer, factor |
| SQf | square |
| SPrelest | estimation vector |
| SP1, SP2, SP3 | spectral powers |
| SP | spectral power vector |
| LOM | power transfer vector |
| SPrelestgain | integration gain |
| SPw | spectral power alternating component |
| | vector |
| rawerrors | error vector |
| weightgain | weight gain |
| F0, F1, F2 | spectral forming filter |
| POW0, POW1, POW2 | measurement device |
| SPOW0, SPOW1, SPOW2 | measurement device output signal |
| PPU0, PPU1, PPU2 | signal processing unit |
| fP0(Ω), fP1(Ω) | measurement output signal |
| fP2(Ω) | |

I claim:

1. An optical information transmission apparatus, comprising:
an optical transmitter for transmitting at least one modulated optical signal; and
an optical receiver for receiving the modulated optical signals, and a control unit in said optical receiver for measuring propagation time variations of at least one of the optical signals.

2. The apparatus according to claim 1, wherein said control unit in said optical receiver is configured to measure the propagation time variations, averaged over occurring values of a transmitter-sided modulation signal, of at least one of the optical signals.

3. The apparatus according to claim 1, wherein said optical transmitter is configured for a transmission of various polarization states of an entirety of at least one existing optical signal.

4. The apparatus according to claim 1, wherein said control unit comprises a signal processing unit, configured to process at least one signal generated in a context of recovering a clock signal, and for delivering a measurement signal for measurement of the propagation time variations.

5. The apparatus according to claim 4, wherein said optical receiver comprises a voltage-controlled oscillator for generating a clock signal, the frequency of which is a function of a frequency control signal.

6. The apparatus according to claim 5, wherein said signal processing unit is configured to evaluate variations of an integral of the frequency control signal as said measurement signal.

7. The apparatus according to claim 3, wherein said optical transmitter comprises a polarization scrambler for scrambling a polarization of said optical signal.

8. The apparatus according to claim 3, wherein said optical transmitter comprises a phase difference modulating device for generating a differential phase modulation between at least two differently polarized optical signals of said optical signals.

9. The apparatus according to claim 8, wherein the two differently polarized optical signals possess a non-constant complex envelope during a bit duration.

10. The apparatus according to claim 1, which further comprises a polarization mode dispersion compensator driven by a polarization mode dispersion control signal derived from said measurement signal.

11. A method for optical information transmission, which comprises:
transmitting at least one modulated optical signal with an optical transmitter;
receiving the optical signal with an optical receiver; and
measuring propagation time variations of at least one of the optical signals in the optical receiver.

12. The method according to claim 11, which comprises measuring the propagation time variations, averaged over occurring values of a transmitter-side modulation signal, of at least one of the optical signals in the optical receiver.

13. The method according to claim 11, which comprises transmitting various polarization states of an entirety of at least one existing optical signal by the optical transmitter.

14. The method according to claim 11, which comprises processing at least one signal generated in a context of recovering a clock signal in the control unit, to generate a measurement signal for measurement of the propagation time variations.

15. The method according to claim 14, which comprises generating clock signal, the frequency of which is a function of a frequency control signal, by way of a voltage-controlled oscillator in said optical receiver.

16. The method according to claim 15, which comprises evaluating variations of an integral of the frequency control signal as the measurement signal in the signal processing unit.

17. The method according to claim 13, which comprises scrambling a polarization of the optical signal in a polarization scrambler at the optical transmitter.

18. The method according to claim 13, which comprises generating a differential phase modulation between at least two differently polarized signals of the optical signals by way of a phase difference modulating device in the optical transmitter.

19. The method according to claim 18, which comprises providing two differently polarized optical signals that possess a non-constant complex envelope during a bit duration.

20. The method according to claim 11, which comprises driving a polarization mode dispersion compensator by a polarization mode dispersion control signal that is derived from the measurement signal.
